(19) United States
(12) Patent Application Publication
(10) Pub. No.: US 2012/0305177 A1
(43) Pub. Date: Dec. 6, 2012

(54) IDENTI-MEDS SYSTEM

(76) Inventors: Diane Simmons, Pickerington, OH (US); Alfred Simmons, Pickerington, OH (US)

(21) Appl. No.: 13/315,892

(22) Filed: Dec. 9, 2011

Related U.S. Application Data
(60) Provisional application No. 61/423,325, filed on Dec. 15, 2010.

(51) Int. Cl. G09F 3/10; B65C 1/02; A61J 1/00

(52) U.S. Cl. 156/247; 206/438

(57) ABSTRACT

An identi-meds system comprising: a medication bottle assembly and a supplementary removeably-coupleable tag for accurately identifying contents contained in bottle(s). The medication bottle assembly includes a cap having an outer surface and an inner surface, a bottle having a body, and a prescription label. The supplementary removeably-coupleable tag includes an adhesive backing comprising an adhesive; and a peel-away sheet. The cap, the bottle, and the prescription label comprise the medication bottle assembly to contain and identify at least one medication in Layman's terms. The inner surface of the cap is removably-coupleable to the body of the bottle to contain and access the medication.

### CROSS-REFERENCE TO RELATED APPLICATION

The present application is related to and claims priority from prior provisional application Ser. No. 61/423,325, filed Dec. 15, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of labels and more specifically relates to labels for use on medicine bottles to translate complex medical terminology into laymen's terms that are readily understood by an average individual.

2. Description of the Related Art

A prescription is a health-care program implemented by a physician or other medical practitioner in the form of instructions that govern the plan of care for an individual patient. Prescriptions may include orders to be performed by a patient, caretaker, nurse, pharmacist or other therapist. Commonly, the term prescription is used to mean an order to take certain medications. Prescriptions have legal implications, as they may indicate that the prescriber takes responsibility for the clinical care of the patient and in particular for monitoring efficacy and safety. Prescriptions are commonly housed in prescription bottles.

Prescription bottles are containers that contain medicine prescribed by physicians. Prescription bottles are generally found and filled in pharmacies. Prescription bottles come in different colors with the most common color being orange. Some prescription bottles are orange so as to prevent light from degrading the medicines located inside through photochemical reactions. However, orange is not the only color used to house prescriptions. Clear containers may be used for medicines that don't degrade in light. There are also blue, dark brown, green, opaque, and red colored containers.

Today, many individuals take multiple medications such as prescriptions for various health conditions. Therefore, a user may have several bottles of medications that they are required to take on a daily or weekly basis. This may become confusing to figure out which bottle is used to treat which medical condition due to the medication labels displaying the formal, technical names of each bottle's contents, typically the prescriptions are written in Latin, a language the vast majority of individuals do not understand.

Unfortunately consumers may accidentally take incorrect medications in inappropriate quantities if they cannot understand the labels. This may pose serious, possibly fatal, health hazards. Additionally, in emergency situations such as allergic reactions or heart conditions, a user may require immediate doses of prescription medication. However, friends and family who are assisting the ailing individuals may not be able to understand the medication labels well enough to select the correct medications. It is desirable that a layman be able to understand what medications are contained within a bottle.

Various attempts have been made to solve problems found in medication labeling art. Among these are found in: U.S. Pat. No. 7,942,451; 2003/0025320; 2003/0189732; U.S. Pat. No. 6,976,628; 2006/0010009; U.S. Pat. Nos. 6,386,367; 7,044,664; and 2006/0163103. This prior art is representative of medication labels.

None of the above inventions and patents, taken either singly or in combination, is seen to describe the invention as claimed. Thus, a need exists for a reliable identi-meds system for use on medicine bottles to translate complex medical terminology into understandable language and to avoid the above-mentioned problems.

### BRIEF SUMMARY OF THE INVENTION

In view of the foregoing disadvantages inherent in the known label art, the present invention provides a novel identi-meds system. The general purpose of the present invention, which will be described subsequently in greater detail is to provide a label for use on medicine bottles to translate complex medical terminology into understandable language. The identi-meds system comprises a series of adhesive stickers displaying labels for the purposes for, or parts of the body that the specific medications have been prescribed for.

An identi-meds system is disclosed herein, a preferred embodiment comprising: a medication bottle assembly and a supplementary removeably-coupleable tag for accurately identifying contents contained in medication bottle(s). The medication bottle assembly includes a cap having an outer surface and an inner surface, a bottle having a body, and a prescription label. The supplementary removeably-coupleable tag includes an adhesive backing comprising an adhesive; and a peel-away sheet. The cap, the bottle, and the prescription label comprise the medication bottle assembly to contain and identify at least one medication. The inner surface of the cap is removably-coupleable to the body of the bottle to contain and access the medication.

The prescription label is located on the body of the bottle and denotes a drug name in medical terminology. The supplementary removeably-coupleable tag comprises indicia describing what medical condition the medication located in the medication bottle is used for in layman's terms written in a language understood by a patient along with a non-professional. The indicia may comprise HEART for example (written in English to be understood by individuals who readily understand English.) The indicia may be written in different language(s).

The adhesive backing is located on a bottom portion of the supplementary removeably-coupleable tag to permit the supplementary removeably-coupleable tag to be removeably-coupled to the cap. The adhesive backing preferably comprises a pressure sensitive adhesive. Further, the supplementary removeably-coupleable tag is removably coupleable to the outer surface of the cap. The peel-away sheet covers the adhesive backing to protect the adhesive until ready for use on the medication bottle assembly and comprises a tab. The tab provides a finger engageable portion whereby the patient may grasp the peel-away sheet to remove the peel-away sheet cover from the adhesive backing on the supplementary removeably-coupleable tag.

A kit is also described herein including a including a plurality of removeably-coupleable labels with various pre-printed indicia; a plurality of blank supplementary removeably-coupleable tags; and a set of user instructions.

A method of using a identi-meds system is disclosed herein preferably comprising the steps of: choosing a supplementary removeably-coupleable tag for accurately identifying the medicine contents of a medication bottle; grasping the supplementary removeably-coupleable tag; peeling away a protective peel off sheet; placing the supplementary removeably-coupleable tag on a cap located on a top portion of the medication bottle; pressing the supplementary removeably-coupleable tag onto the cap on the medication bottle; thereby identifying the medication bottle when needed or prescribed; and writing a medical condition on a blank supplementary removeably-coupleable tag as a redundant identifier in combination with a prescription label.

The present invention holds significant improvements and serves as an identi-meds system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, identi-meds system constructed and operative according to the teachings of the present invention.

FIG. 1 shows a perspective view illustrating an identi-meds system in an ‘in-use’ condition according to an embodiment of the present invention.

FIG. 2 is a perspective view illustrating a medication bottle assembly having a supplementary removeably-coupleable tag for accurately identifying contents contained inside of a bottle(s) of the identi-meds system according to an embodiment of the present invention.

FIG. 3 is a perspective view illustrating the supplementary removeably-coupleable tag for accurately identifying contents contained in the bottle(s) of the identi-meds system according to an embodiment of the present invention.

FIG. 4 is a perspective view illustrating the supplementary removeably-coupleable tag for accurately identifying contents contained in the bottle(s) of the identi-meds system comprising indicia according to an embodiment of the present invention.

FIG. 5 is a perspective view illustrating another view of the supplementary removeably-coupleable tag for accurately identifying contents contained in the bottle(s) of the identi-meds system comprising indicia according to an embodiment of the present invention.

FIG. 6 is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a labeling device and more particularly to an identi-meds system for use on medicine bottles to translate complex medical terminology into understandable language for laymen and to avoid the above-mentioned problems.

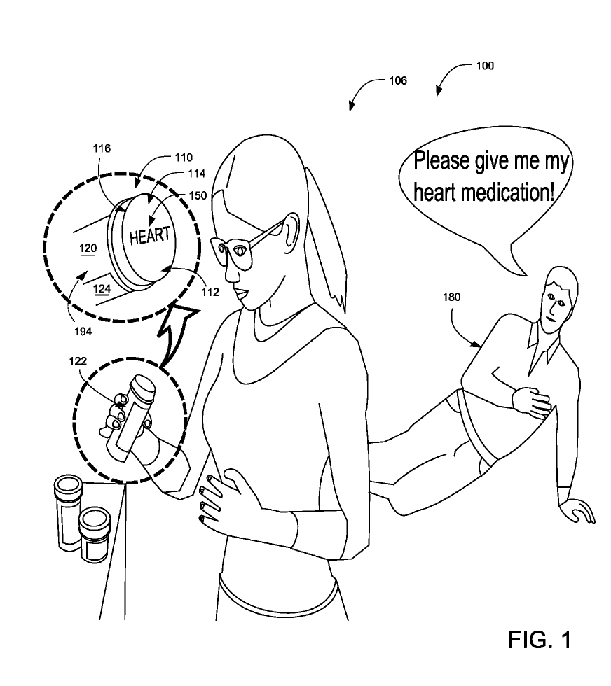

Now referring to the drawings by numerals of reference there is shown in FIG. 1, a perspective view illustrating identi-meds system 100 (medication bottles identification system) in ‘in-use’ condition 106 as removeably-coupleable to bottle (s) 120 according to an embodiment of the present invention. Identi-meds system 100 preferably allows user(s) 180 to accurately identify contents inside of bottle(s) 120. Further, identi-meds system 100 is designed to translate complex medical terminology (Latin verbiage) into understandable language.

Identi-meds system 100 comprises: medication bottle assembly 110 and supplementary removeably-coupleable tag 130 for accurately identifying contents contained in bottle(s) 120. Medication bottle assembly 110 includes cap 112 having outer surface 114 and inner surface 116, bottle 120 having body 122, and prescription label 124. Cap 112, bottle 120, and prescription label 124 comprise medication bottle assembly 110 to contain and identify at least one medication. Inner surface 116 of cap 112 is removably-coupleable to body 122 of bottle 120 to contain and access medication.

Prescription label 124 is located on body 122 of bottle 120 and denotes a drug name in medical terminology. Prescription label 124 may comprise Latin. Further prescription label may include name of medication 194 in complex terminology. Supplementary removeably-coupleable tag 130 located on cap 112 provides in layman's terms a specific indication of medication 194 contained within medication bottle assembly 110 such that a non-professional can understand what medication 194 is contained therein at a glance from just prescription label 124.

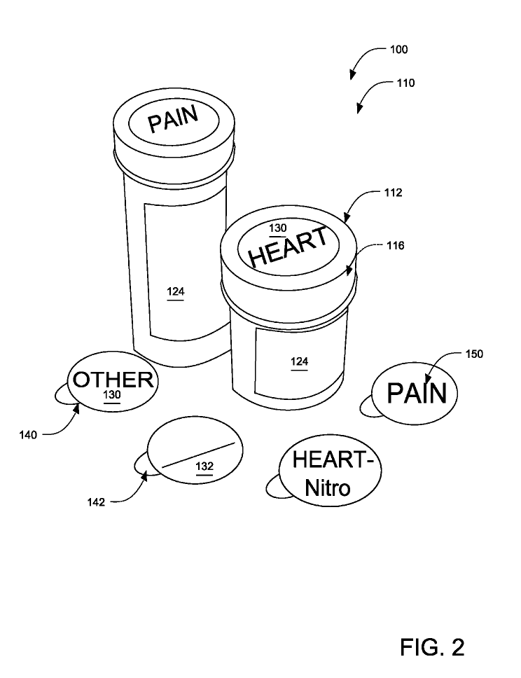

Referring now to FIG. 2, illustrating a perspective view illustrating medication bottle assembly 110 having supplementary removeably-coupleable tag 130 for accurately identifying contents contained inside of bottle(s) 120 of identi-meds system 100 according to an embodiment of the present invention.

Supplementary removeably-coupleable tag 130 comprises indicia 150 describing what medical condition medication 194 is located in bottle(s) 120 is used for in layman's terms written in a language understood by patient 180. Supplementary removeably-coupleable tag 130 is preferably removably coupleable to outer surface 114 of cap 112. Supplementary removeably-coupleable tag 130 may include blank supplementary removeably-coupleable tag 132 and not include any form of indicia 150 wherein patient(s) 180 may write custom indicia as per a specific medical condition. A benefit of supplementary removeably-coupleable tag 130 not comprising any indicia 150 (blank supplementary removeably-coupleable tag 132) is that patient 180 may write indicia 150 to describe each bottle(s) 120 in terms that patient(s) 180 or a caregiver will preferably understand in a time of duress for example. Also, medication 194 located in bottle(s) 120 may comprise a rare form as indicia 150 located on supplementary removeably-coupleable tag 130 does not include, but patient(s) 180 still prefers a simple description on cap 112 of bottle(s) 120.

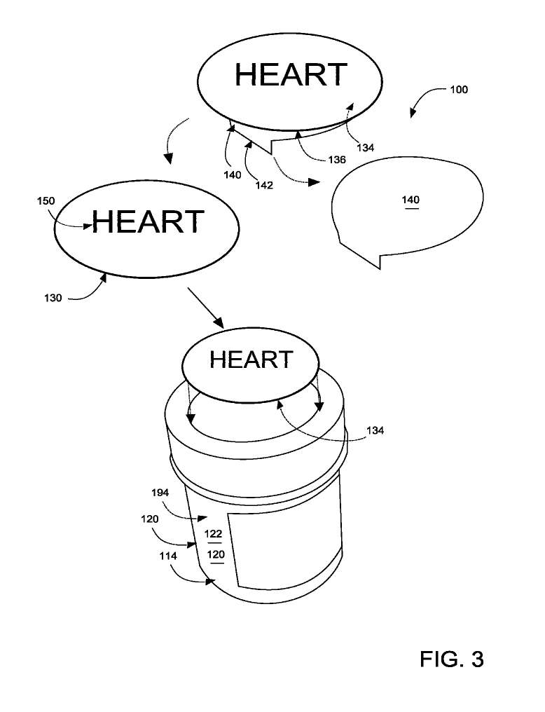

Referring now to FIG. 3 illustrating a perspective view illustrating supplementary removeably-coupleable tag 130 for accurately identifying contents contained in bottle(s) 120 of identi-meds system 100 according to an embodiment of the present invention.

Supplementary removeably-coupleable tag 130 includes adhesive backing 134 comprising at least one adhesive; and peel-away sheet 140. The adhesive located on adhesive backing 134 may comprise a pressure sensitive adhesive (PSA). Pressure sensitive adhesives are preferably designed for either permanent or removable applications. Permanent PSAs may be initially removable (for example to recover mislabeled goods) and build adhesion to a permanent bond after several hours or days.

Removable adhesives as disclosed herein are designed to form a temporary bond, and ideally can be removed after months or years without leaving residue on the adherend. Removable adhesives generally are used in applications such as surface protection films, masking tapes, bookmark and note papers, price marking labels, promotional graphics materials, and for skin contact (wound care dressings, EKG electrodes, athletic tape, analgesic and transdermal drug patches, etc.). Some removable adhesives are designed to repeatedly stick and unstuck; these are the preferred adhesives used herein. PSAs have low adhesion and generally can not support much weight. Adhesive backing 132 is located on bottom portion 134 of supplementary removeably-coupleable tag 130 to permit supplementary removeably-coupleable tag 130 to be removeably-coupleable to cap 112. Peel-away sheet 140 preferably covers adhesive backing 132 to protect the adhesive until ready for use on medication bottle assembly 110. Peel-away sheet 140 comprises tab 142 for ease of use. Tab 142 preferably provides finger engageable portion 144 whereby patient 180 may grasp peel-away sheet 140 to remove peel-away sheet 140 from adhesive backing 134 on supplementary removeably-coupleable tag 130.

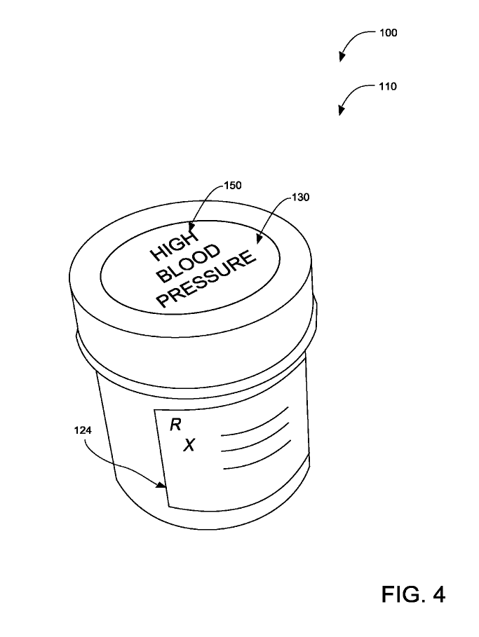

Referring now to FIGS. 4 & 5 showing a perspective view illustrating supplementary removeably-coupleable tag 130 for accurately identifying contents contained in bottle(s) 180 of identi-meds system 100 comprising indicia 150 according to an embodiment of the present invention.

Indicia 150 preferably comprises HEART, PAIN, BLOOD PRESSURE, CHOLESTEROL or the like. Upon reading this specification, it should be appreciated that, under appropriate circumstances, considering such issues as user preferences, design preference, structural requirements, marketing preferences, cost, available materials, technological advances, etc., other indicia arrangements such as, for example, ARTHRITIS, NAUSEA, GASTROENTEROLOGY, MIGRAINE, etc., may be sufficient. Further description may be used as well for example indicia 150 may state HEART-Nitro.

Kit 450 is also described herein including a plurality of supplementary removeably-coupleable tags 130 with various pre-printed indicias (150); a plurality of blank supplementary removeably-coupleable tags 132; and a set of user instructions.

Identi-meds system 100 may be manufactured and provided for sale in a wide variety of sizes and shapes for a wide assortment of container and medication name applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, different adhesives/fastening means used, customized colors/designs, parts may be sold separately, etc., may be sufficient. For example Identi-meds system 100 may comprise color-coding.

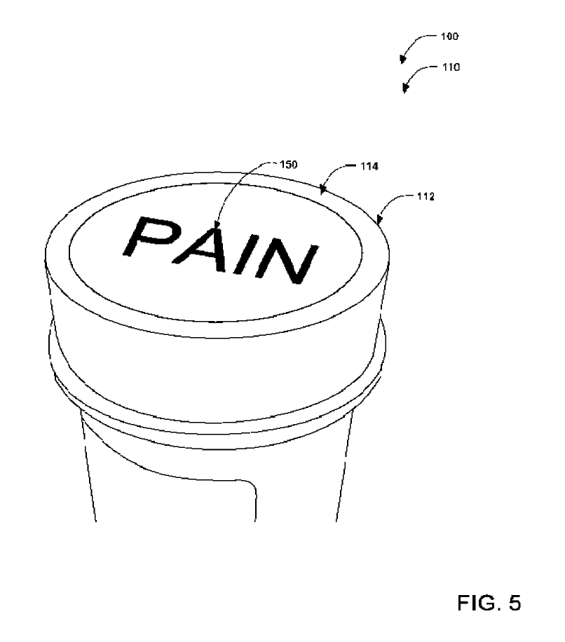

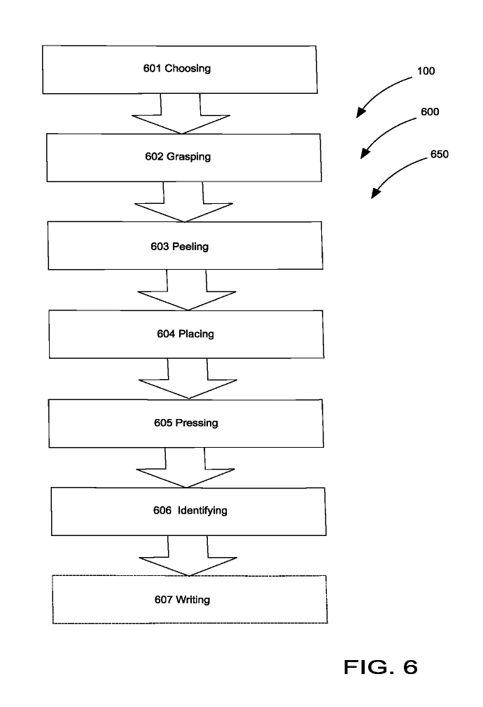

Referring now to FIG. 6, a flowchart 650 illustrating a method of using (method of use 500) identi-meds system 100 according to an embodiment of the present invention of FIGS. 1-5.

A method of using (enabling method of use 600) identi-meds system 100 preferably comprises the steps of: step one 601 choosing supplementary removeably coupleable tag 130 for accurately identifying medicine contents of bottle(s) 120; step two 602 grasping supplementary removeably-coupleable tag 130; peeling away peel-away sheet 140; step three 603 placing supplementary removeably-coupleable tag 130 on cap 112 located on a top portion of bottle(s) 120; step four 604 pressing supplementary removeably-coupleable tag 130 onto cap 112 on bottle(s) 120; step five 605 identifying bottle(s) 120 when needed or prescribed; and step six 606 writing a medical condition on blank supplementary removeably-coupleable tag 132 as a redundant identifier in combination with a prescription label.

It should be noted that step 605 is an optional step and may not be implemented in all cases. Optional steps of method 600 are illustrated using dotted lines in FIG. 6 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A medication bottles identification system comprising:
a medication bottle assembly having;
a cap having an outer surface and an inner surface;
a bottle having a body; and
a prescription label;
a supplementary removeably-coupleable tag for accurately identifying contents contained in said medication bottle(s) having;
an adhesive backing comprising an adhesive; and
a peel-away sheet;
wherein said cap, said bottle, and said prescription label comprise said medication bottle assembly to contain and identify at least one medication;
wherein said inner surface of said cap is removably coupleable to said body of said bottle to contain and access said medication;
wherein said prescription label is located on said body of said bottle and denotes a drug name in medical terminology;
wherein said supplementary removeably-coupleable tag comprises indicia describing what medical condition said medication located in said medication bottle is used for in layman's terms;
wherein said supplementary removeably-coupleable tag is removably coupleable to said outer surface of said cap;
wherein said adhesive backing is located on a bottom portion of said supplementary removeably-coupleable tag to permit said supplementary removeably-coupleable tag to be removeably-coupleable to said cap;
wherein said peel-away sheet covers said adhesive backing to protect said adhesive until ready for use on said medication bottle assembly; and
wherein said supplementary removeably-coupleable tag located on said cap provides in said layman's terms a specific indication of said medication contained within said medication bottle assembly such that a non-professional can understand what said medication is contained therein at a glance.

2. The medication bottles identification system of claim 1 wherein said prescription label comprises Latin.

3. The medication bottles identification system of claim 1 wherein said supplementary removeably-coupleable tag comprises said indicia in said layman's terms written in a language understood by a patient.

4. The medication bottles identification system of claim 3 wherein said indicia comprises HEART.

5. The medication bottles identification system of claim 3 wherein said indicia comprises PAIN.

6. The medication bottles identification system of claim 3 wherein said indicia comprises BLOOD PRESSURE.

7. The medication bottles identification system of claim 3 wherein said indicia comprises CHOLESTEROL.

8. The medication bottles identification system of claim 3 wherein said indicia comprises ARTHRITIS.

9. The medication bottles identification system of claim 3 wherein said indicia comprises NAUSEA.

10. The medication bottles identification system of claim 4 wherein said indicia comprises HEART-Nitro.

11. The medication bottles identification system of claim 3 wherein said indicia comprises MIGRAINE.

12. The medication bottles identification system of claim 1 wherein said supplementary removeably-coupleable tag is blank wherein a patient may write custom said indicia as per a specific medical condition.

13. The medication bottles identification system of claim 1 wherein said adhesive backing comprises a pressure sensitive adhesive.

14. The medication bottles identification system of claim 12 wherein said peel-away sheet comprise a tab.

15. The medication bottles identification system of claim 14 wherein said tab provides a finger engageable portion whereby said patient may grasp said peel-away sheet to remove said peel-away sheet from said adhesive backing on said supplementary removeably-coupleable tag.

16. A medication bottles identification system comprising:
a medication bottle assembly having;
a cap having an outer surface and an inner surface;
a bottle having a body; and
a prescription label;
a supplementary removeably-coupleable tag for accurately identifying contents contained in said medication bottle(s) having;
an adhesive backing comprising an adhesive; and
a peel-away sheet;
wherein said cap, said bottle, and said prescription label comprise said medication bottle assembly to contain and identify at least one medication;
wherein said inner surface of said cap is removably coupleable to said body of said bottle to contain and access said medication;
wherein said prescription label is located on said body of said bottle and denotes a drug name in medical terminology;
wherein said prescription label comprises Latin;
wherein said supplementary removeably-coupleable tag comprises indicia describing what medical condition said medication located in said medication bottle is used for in layman's terms written in a language understood by a patient;
wherein said supplementary removeably-coupleable tag is removably coupleable to said outer surface of said cap;
wherein said adhesive backing is located on a bottom portion of said supplementary removeably-coupleable tag to permit said supplementary removeably-coupleable tag to be removeably-coupleable to said cap;
wherein said peel-away sheet covers said adhesive backing to protect said adhesive until ready for use on said medication bottle assembly;
wherein said adhesive backing comprises a pressure sensitive adhesive;
wherein said peel-away sheet comprise a tab;
wherein said tab provides a finger engageable portion whereby said patient may grasp said peel-away sheet to remove said peel-away sheet cover from said adhesive backing on said supplementary removeably-coupleable tag; and
wherein said supplementary removeably-coupleable tag located on said cap provides in said layman's terms a specific indication of said medication contained within said medication bottle assembly such that a non-professional can understand what said medication is contained therein at a glance.

17. The medication bottles identification system of claim 16 further comprising a kit including a plurality of supplementary removeably-coupleable tags with various pre-printed said indicias; a plurality of blank said supplementary removeably-coupleable tags; and a set of user instructions.

18. A method of using a medication bottles identification system comprising the steps of:
choosing a supplementary removeably-coupleable tag for accurately identifying said medicine contents of medication bottles;
grasping said supplementary removeably-coupleable tag;
peeling away a protective peel off sheet;
placing said supplementary removeably-coupleable tag on a cap located on a top portion of said medication bottle;
pressing said supplementary removeably-coupleable tag onto said cap on said medication bottle; and
identifying said medication bottle when needed or prescribed.

19. The method of using the medication bottles identification system of claim 18 further comprising the steps of writing a medical condition on a blank said supplementary removeably-coupleable tag as a redundant identifier in combination with a prescription label.
